(19) United States
(12) Patent Application Publication
(10) Pub. No.: US 2022/0063413 A1
(43) Pub. Date: Mar. 3, 2022

(54) Power Collection Module

(71) Applicant: Richard L. Lewis, Essex, IA (US)

(72) Inventor: Richard L. Lewis, Essex, IA (US)

(73) Assignee: Zero Electric Vehicles Corp., Mesa, AZ (US)

(21) Appl. No.: 16/873,968

(22) Filed: Sep. 1, 2020

(51) Int. Cl. B60L 1/00; H02J 7/00; B60L 3/12; B60L 53/24; B60L 50/60

(52) U.S. Cl. CPC B60L 1/20; H02J 7/007; H02J 7/0047; B60L 3/12; B60L 7/16; B60L 50/60; H02J 2207/20; B60L 2210/12; B60L 2210/14; B60L 53/24

(57) ABSTRACT

The driving range of an electrically powered motor vehicle can be extended by employing a plurality of different types of regenerative power devices on the vehicle for producing electricity and collecting the power generated by each in an efficient module having both DC to DC step up and DC to DC step down converters that output the collected power at a predetermined voltage for selectively providing power to the vehicle's storage battery system or directly to a vehicle accessory.

### FIELD OF THE INVENTION

The present invention relates to electrical power collection and distribution in a motor vehicle. More specifically, a first implementation of the invention relates to the collection of electrical power from a plurality of types of electrical generation devices or systems each of which has its own voltage and current output levels and provision of the collected power to a standard output at a predetermined voltage level for charging of a storage battery system. A second implementation of the invention relates to the collection of electrical power from a plurality of types of electrical generation devices and selectively providing the collected power a storage battery system at a first predetermined voltage and providing the collected power to a vehicle auxiliary device instead of to a storage battery system.

### SUMMARY OF THE INVENTION

In the management of electrical power in a motor vehicle it is desirable to have a consistent source of electricity available at all times. The source of supply is preferably available at a predetermined voltage level and at power levels consistent with peak power demands. When power is being generated from renewable sources, it is not always possible to generate power when and where needed and at the desired level of power. Thus, energy storage systems and devices have been created in an effort to keep the stored energy available for peak power demands. Typical of such storage systems are banks of rechargeable batteries.

Numerous types of renewable energy sources have been identified and include solar energy, thermal energy, chemical energy, potential energy, and kinetic energy. There are many well-known mechanisms available for capture of the energy from these sources for the production of electricity. The present invention has particular utility in the capture and management of solar, potential and kinetic energy for use in vehicles, and more specifically energy available from regenerative braking, aerodynamic energy capture, vibration energy capture, and solar energy capture. Systems on a vehicle that capture these energy sources for creation of electricity are referred to as energy recapture systems.

With renewable energy sources, there is the possibility of providing the electrical power generated directly to on board vehicle systems without utilizing the battery system, thereby eliminating the energy losses associated with charging and discharging the batteries. This advantage becomes evident when the vehicle battery system is fully charged and the vehicle is not operating. Allowing systems such as air conditioning to operate from the power produced from renewable sources provides the possibility of extending the vehicles range once operation resumes because the batteries have remained fully charged.

The energy from all these renewable sources can be converted into electricity by known devices but the outputs from these power generation devices have various different voltages and current levels. Also, their availability is not consistent due to variations in the environment and operation of the vehicle. For instance, braking is intermittent, so regenerative braking produces intermittent electrical power. Similarly, solar energy is a function of the weather and intensity and angle of the sun while wind energy is a function of vehicle speed—also a variable. Vibration energy also varies as a function of the terrain over which the vehicle is travelling. An objective of the collection of the power generated from these various energy sources is to combine and provide a source of electrical energy to be used not only by all the electrical devices on a vehicle, but also to charge the storage battery system. In an electric vehicle this would be the storage battery system that powers the vehicle. The device that performs this power collection function is referred to herein as a Power Collection Module (PCM).

### BRIEF DESCRIPTION OF THE DRAWINGS

FIG. 1 is an illustration of an implementation of the invention comprising multiple types of power generation devices.

FIG. 2 is an illustration of a power collection module in accordance with the invention.

FIG. 3 is a schematic of an embodiment of the power collection module of the invention.

### DETAILED DESCRIPTION OF THE INVENTION

The preferred embodiment of the invention's PCM is comprised of an enclosed container, DC-DC Converters, fans for cooling, wiring, input and output connectors, and an energy meter for monitoring the output. The DC-DC step-up converter is a power converter that steps up voltage, while stepping down current, from its input to its output. The output voltage is greater than the input voltage, and the output current is lower than the input current such that power is conserved (Power=Voltage×Current). The DC-DC step-down converter is a power converter that steps down voltage, while stepping up current, from its input to its output. The output voltage is lower than the input voltage, and the output current is greater than the input current such that power is conserved. The diodes that are connected in series with the positive output of each DC-DC converter are to protect the converters not only from erroneous voltages from the outside, but also erroneous voltages from each of the other converters in case of failure. The diodes will have a maximum current rating capability and a voltage drop when current flows through them in the “forward” direction. The grounding bars are screw terminal blocks of metal with a specified number of screws used to attach all the positive and negative output wires of the DC-DC Converters together and to the output connector of the PCM for supplying the single output power. The fans are used to provide air flow within the enclosure to prevent any of the DC-DC converters from overheating. They are arranged in a push-pull configuration such that one fan pushes air into the enclosure from the outside, and the other fan pulls air from inside the enclosure to the outside. They are 12 VDC fans, but are connected in series with each other to operate at 7 VDC. The energy meter is a voltmeter including a resistive shunt that not only measures the output voltage of a circuit, but also calculates the output current, the output power, the output energy, and the external resistance of the load connected to the output. The meter can be mounted directly onto the PCM enclosure or in a remote location using a cable. Each DC-DC converter (both step-up and step-down) is electrically connected to the regenerative sources of power (Regens). After each converter has been adjusted from the individual input voltages to a specified and calibrated level of output voltages, and protected by the series diodes, they are combined electrically using the grounding bar which is connected to the output connector of the PCM.

The energy meter is connected to the output of the PCM internally to monitor the voltage while calculating the previously stated parameters.

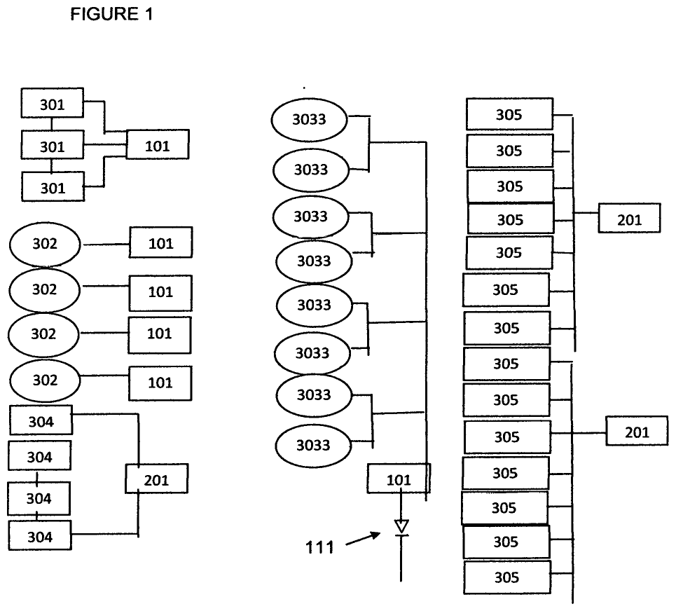

FIG. 1 illustrates a preferred implementation of the invention wherein there are a plurality of DC-DC converters 101, 201 and a plurality of types of power generation devices 301, 302, 303, 304 and 305. DC-DC converters 101 are step up converters while DC-DC converters 201 are step down converters. Step-up and step-down DC-DC converters are commercially available from numerous sources and can be selected based on the power levels and specific current and/or voltage levels specified for the intended application. The various power generation devices are connected to appropriate ones of the DC-DC converters so as to provide as much power as is available at the desired output voltage. Thus, when a particular type of power generation device provides an output voltage above 14 volts a step down converter can be used and conversely when the generation of power is at less than 14 volts a step up DC-DC converter can be employed. In practice, it is possible to arrange a number of power generation devices in series so the voltage at which power is made available will be the combined voltages of the series-connected devices. In the arrangement shown in the FIG. 1, the intended output voltage at the converter output is 14 volts and for the step-up converters the anticipated input voltages are less than 14 volts, while the converter output voltage, provided at the converter output, is also 14 volts.

One type of electrical generation device is a solar film or solar panel power generator, identified as a solar generator 301. The total power generated by the three illustrated solar generator devices 301 is specified as a function of the combined power output of the multiple devices as generation sources. Three solar generators 301 each produce an output voltage of 12 volts and a current of about 5.3 amps. The three solar generators 301 are connected in parallel and provide a combined output current of roughly 16 amps at their 12 volt output voltage. The combined outputs of the three solar panels 301 are provided to one step up DC-DC step up converter 101 where the voltage is stepped up to 14 volts. The output of the step-up DC-DC converter 101 provides between 13 and 14 amps at its 14 volt output level.

Another type of electrical generation device is a wind driven device 302 that can be mounted to the vehicle for power generation as the vehicle travels through the air, creating its own wind. The idea of using wind as a power generation source dates back at least as far as the invention of the windmill for pumping water. More recently there have been increasing efforts to generate power from the wind encountered by a moving vehicle. A recent example is shown in U.S. Pat. No. 10,533,536, “Wind powered generating device installed in a vehicle” dated Jan. 14, 2020. For purposes of this invention, a device 302 of this type is selected so it can (at optimum performance conditions) generate an output of up to 12 amps at a ten volt output voltage. A plurality of these devices 302 are provided on the vehicle and are individually connected to step-up DC-DC converters 101. The 10 volt input of each converter 101 is converted up to 14 volts resulting in an output current of slightly under 9 amps for each device 302 at the 14 volt output voltage level, and a combined output for the 4 illustrated converters of nearly 36 amps.

Yet another type of power generation device for a motor vehicle is a vibration-based power generator 303. Devices of this type employ vibration energy to move a magnet relative to a coil for power generation. Regenerative shock absorbers have been proposed for this purpose. More recently regenerative vibration sensors have been developed that sense vehicle vibrations that are much less severe, and correspondingly produce lower levels of regenerative power) than the type of movements addressed by shock absorbers. For purposes of this invention, a vibration regeneration device 303 is selected so it can (when subjected to significant mechanical oscillations) generate roughly 0.5 amps at an output voltage of 5 volts. In the illustrated implementation of the invention, pairs of these devices 303 are series connected, each pair then providing its 0.5 amps at 10 volts output. Four pairs are illustrated, although there may be as many or as few pairs as desired depending on the system requirements and the vehicle dynamics. The 10 volt output of each of the four pairs is connected to the DC-DC step-up converter 101, resulting in an input current of 2 amps and an output current of just under 1.5 amps.

As further illustrated in FIG. 1, there are four Hydrogen ThermoElectricGenerators 304 each capable of generating 4 amps at an output level of 5 volts. By connecting the four in series a combined output of 4 amps is produced at 20 volts. This output is connected to step-down converter 201 which provides somewhat over 5.5 amps at a 14 volt output. Also, the waste heat from the vehicle can be used to power a series of Lithium ion TEG devices 305. The preferred implementation of the invention illustrated in FIG. 1 shows two groups of seven Li-ion TEG devices, each group connected in series. Each device 305 produces 4 amps at its 5 volt output. The combined seven devices of each group provide 4 amps at a combined voltage of 35 volts. The two groups combined produce a total of 8 amps at 35 volts. Each group has its output provided to an associated step-down DC-DC converter 201 where the 35 volts is stepped down to 14 volts resulting in an output current of 10 amps, 20 amps for the two combined.

The nine illustrated converters 101, 201 provide a combined output capability of nearl 70 amps at the predetermined voltage of 14 volts. This combination of devices provides nearly a kilowatt of potential power output. In practice it is possible to employ as many or as few power generation devices 301-305 as practical for the particular vehicle being operated. In an electrically powered vehicle there is increasing interest in finding ways to extend the range of the vehicle on a single battery charge. As a result, there is increasing interest in regenerative energy sources. In addition to those mentioned with respect to the embodiment of FIG. 1, regenerative braking and regenerative shock absorbers are viable additional power reclamation sources and could be readily added in parallel to the power sources 301-305. Suitable step-up and/or step-down converters 101, 201 just need to be provided to bring the supplied power to the desired output voltage.

A power collection module that can be connected to a battery system 563, or under control of a vehicle controller 561, connected to an auxiliary system 562. This facilitates reducing the burden on the storage battery system when sufficient energy is already being recaptured by the power generation devices.

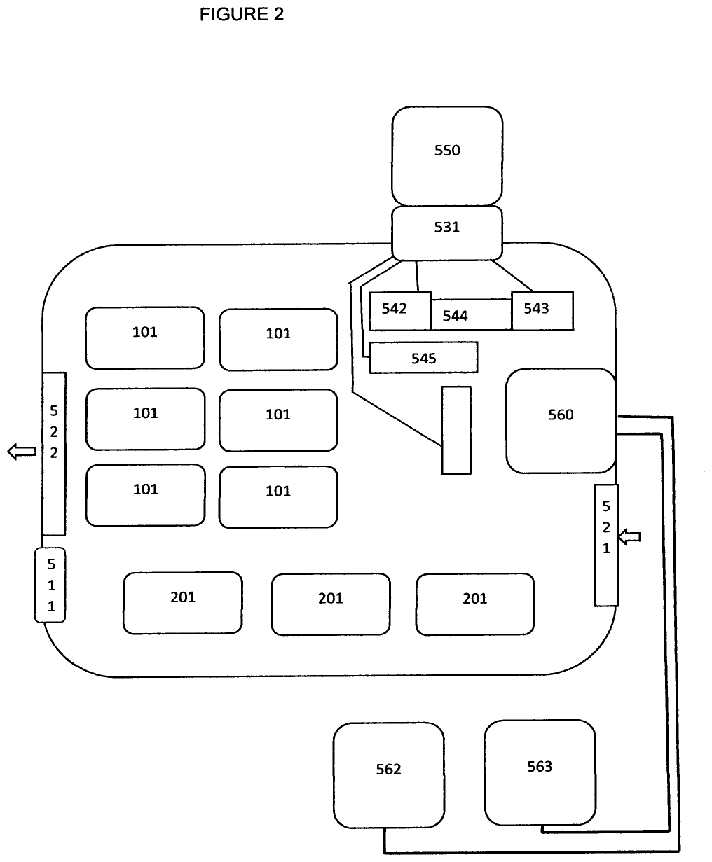

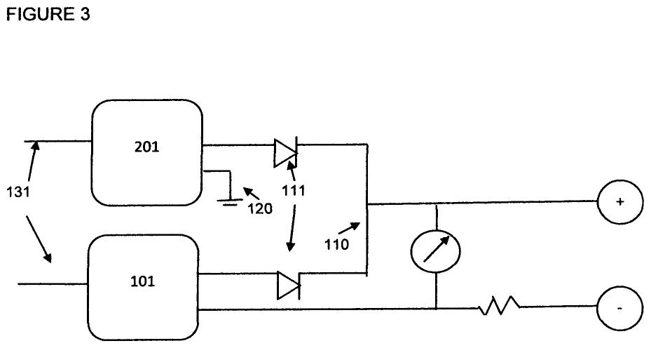

Referring to FIG. 2, the power collection module is shown, having six power step-up DC-DC converters 101 and three power step-down DC-DC converters 201. A housing 500 includes a connector port 511 for connection to the output lines (not shown) from the various power generators 301-305. Two cooling fans 521, 522 are internally mounted to housing 500 at fan ports 520 to draw air into (via fan 521) and expel air from (via fan 522) the interior of the housing. Energy meter connector port 531 is provided in the housing 500 for connection of external energy meter 550. Also included within the housing is a shunt 544 connected between two terminals 542, 543 providing a known resistive load (shunt for determination of the amount of power being delivered via DC output 560. Terminals 542 and 543 are connected to the outputs of the DC-DC converters, electrically tying them together at the preselected 14 volt output voltage. To protect the individual converters from electrical damage, protective diodes 111 (shown in FIGS. 1 and 3) are provided on the positive output line 110 leading from each converter to the common connection point, bus bar 545. These diodes are rated to allow maximum forward current flow from the converters, and they serve to block external voltage spikes, either from outside the system or from a faulty component within another part of the system.

FIG. 3 illustrates one DC-DC step down converter 201 and one DC-DC step up converter 201. As shown the 14 volt output 110 from each converter includes a protective diode 111 on the positive output line and the negative output lines 120 are connected to ground. Inputs 131 from the power generation devices are shown and the common connection 545 of the 14 Volt output lines are illustrated. The energy meter 550 is shown connected between the output line 561 and system ground for monitoring the voltage and power being supplied by the array of converters.

As can be recognized from this disclosure there is advantage to be obtained by connecting relatively lower voltage power generation devices in series to bring the cumulative output voltage to a higher level that is still below the converter's desired output voltage. By arranging the power generation devices in this manner it is possible to reduce the number of DC to DC step up converters needed to collect all of the power generated from these multiple power generation devices. In similar fashion when the voltage provided by each of a plurality of individual power generation devices is higher than the desired output voltage of the power collection module the multiple individual power generation devices can be connected in parallel thereby keeping the number of DC to DC step down converters to a minimum. As a further efficiency improvement it is possible to connect the low voltage systems in series and the high voltage power generation devices in parallel to bring down the required number of each of the step up converters and the DC to DC step down converters. In yet another variation of the inventive concept, it is possible to combine any combination of power generation devices in series in order to optimize the number of DC to DC converters required. For instance, if one type of power generation device provides a 2 amp output at 10 volts and another power generation device provides a 2 amp output at 3 volts, the two could be combined in series and output 2 amps at 13 volts. This avoids the need for separate converters for the two separate types of power generation devices. Parallel connections provide a similar opportunity for efficiency. When different types of power generation devices produce output power at the same output voltage, they can be connected in parallel, again, to reduce the number of DC to DC converters needed.

The energy meter in this example displays the following parameters that are useful in monitoring the PCM output: the voltage level of the output in Volts; the current level being drawn in Amps or milliamps; the power level being supplied in Watts or milliwatts; the rate at which electrical power is being supplied in Watt-hours; and, the resistance of the load.

The “shunt” is a metal plate with a calibrated resistance that allows the energy meter to calculate the amount of current being drawn by measuring the voltage drop across the shunt.

There are two types of DC-DC converters used; 1. Step-Down and 2. Step-Up. The step-down converters are used with any Regens (or combination of Regens) that have output voltages above 14 volts so they can bring those higher voltages down to the level of 14.0 volts, but at the same time they also bring the current levels up slightly. The step-up converters are used with any Regens (or combination of Regens) that have output voltages below 14 volts so they can bring those lower voltages up to the level of 14.0 volts, but at the same time they also bring the current levels down slightly. Power must be conserved by the equation:

Power=Voltage×Current;P=EI.

The diode 111 and grounding bar 545 used to tie the outputs together are shown in FIG. 3 and FIG. 2 respectively.

Each Regen is connected to either a step-up or a step-down converter through a connector with a specified number of pins depending upon the number of Regens. Then, depending upon the maximum voltage and current outputs from each Regen, the Regens can be configured by either connecting them individually, or in series or in parallel or both. An example of a Regen configuration to the DC-DC converters is shown in FIG. 1.

The grounding bars are used to tie the positive and negative outputs of all the converters together in order to form a single output on the PCM. The housing also accommodates two fans to provide air flow across the converters where one fan pushes air into the enclosure and the other fan pulls the air out. The fans cool the converters so they do not overheat.

An example of the physical layout of the components within an enclosure 500 (the housing) is shown in FIG. 2 along with the energy meter 550 and controller 560 that may also be included, optionally integrated with the converters within the housing, or as separate components as illustrated. They might also be attached to the exterior of the housing 500.

1. In an electrically driven motor vehicle having a storage battery system and having a plurality of energy recapture systems, a power collection module comprising:
a first DC to DC converter for stepping up a DC voltage from a first one of said energy recapture systems to a desired voltage for charging said storage battery system, and
a second DC to DC converter for stepping down a DC voltage from a second one of said energy recapture systems to said desired voltage for charging said storage battery system.

2. In an electrically driven motor vehicle having a plurality of energy recapture systems and having a vehicle electrical system comprising a storage battery system and a vehicle auxiliary system, a power collection module comprising:
a first DC to DC converter for supplying electric power from a first one of said energy recapture systems to a first converter output at a predetermined output voltage for supplying power to said vehicle electrical system, and
a second DC to DC converter for supplying electric power from a second one of said energy recapture systems to a second converter output at a predetermined output voltage for supplying power to said vehicle electrical system.

3. A power collection module as claimed in claim 2 wherein said first and second outputs are connected in parallel to said storage battery system.

4. A power collection module as claimed in claim 2 further comprising a power distribution controller that can selectively direct power from said module to said storage battery system, or to said vehicle auxiliary system.

5. A power collection module as claimed in claim 2 wherein said first one of said energy recapture systems is a plurality of energy recapture devices connected in series.

6. A power collection module as claimed in claim 2 wherein said second one of said energy recapture systems is a plurality of devices connected in parallel.

7. A power collection module as claimed in claim 2 wherein said first one of said energy recapture systems is a plurality of devices connected in series and wherein said second one of said energy recapture systems is a plurality of devices connected in parallel.

8. A power collection module as claimed in claim 2 wherein said power collection module further comprises an output controller for selectively directing output power to one of said storage battery system and said vehicle auxiliary system.

9. A power collection module as claimed in claim 2 wherein said power collection module further includes an energy meter displaying the output voltage of said power collection module, the output current and output power of said power collection module and the output energy, and the external resistance of the load connected to the output of said power collection module.

10. A power collection module as claimed in claim 1 wherein said first energy recapture system comprises a plurality of thermoelectric generators connected in series and wherein said second energy recapture system comprises a plurality of vibration-based power generators connected in series.

11. A power collection module as claimed in claim 2 wherein:
said first DC to DC converter is a step up converter for supplying electric power from a first one of said energy recapture systems to a first converter output at a predetermined output voltage for supplying power to said vehicle electrical system, and
said second DC to DC converter is a step down converter for supplying electric power from a second one of said energy recapture systems to a second converter output at a predetermined output voltage for supplying power to said vehicle electrical system, and wherein
said first one of said energy recapture systems comprises a plurality of thermo electric generators connected in series, and
said second one of said energy recapture systems is a wind-based generator.
